(19) United States
(12) Patent Application Publication
(10) Pub. No.: US 2003/0195438 A1
(43) Pub. Date: Oct. 16, 2003

(54) Method and apparatus to treat glaucoma

(76) Inventor: Phillip J. Petillo, Ocean, NJ (US)

Correspondence Address: MICHAEL B. EINSCHLAG, ESQ., 25680 FERNHILL DRIVE, LOS ALTOS HILLS, CA, 94024, US

(21) Appl. No.: 10/122,958

(22) Filed: Apr. 12, 2002

(51) Int. Cl. A61H 23/02

(52) U.S. Cl. 601/15; 601/46; 601/78

(57) ABSTRACT

One embodiment of the present invention is a method for use in treating glaucoma of a patient's eye which includes a step of vibrating the eye.

### TECHNICAL FIELD OF THE INVENTION

One or more embodiments of the present invention pertain to method and apparatus to treat glaucoma.

### BACKGROUND OF THE INVENTION

A space in front of a lens of an eye contains watery fluid (the aqueous humor). This space is divided into two parts: (a) an anterior chamber (the anterior chamber is located between a back surface of the cornea and a front face of the iris), and (b) a posterior chamber (the posterior chamber is located behind the iris, but in front, and at the side, of the lens). The aqueous humor provides nourishment for internal, avascular structures of the anterior chamber like the corneal endothelium and the iris face.

Aqueous humor is secreted into the posterior chamber by the ciliary process of the ciliary body. It then passes through the pupil into the anterior chamber, and then flows to the anterior chamber angle (the anterior chamber angle is located at a junction of the cornea and the iris). A primary (conventional) aqueous humor outflow system of the eye is located in the anterior chamber angle, and accounts for about 83% to 96% of aqueous humor outflow in the human eye under normal circumstances. The anterior chamber angle acts as a drainage system of the inside of the eye through the trabecular meshwork, the canal of Schlemm, intrascleral channels, and episcleral and conjunctival veins. A secondary (alternative) aqueous humor outflow system (known as the unconventional, or uveoscleral, aqueous humor outflow system) accounts for about 5% to 15% of aqueous humor outflow in the human eye under normal circumstances.

Glaucoma relates to a group of disorders characterized by progressive damage to an eye that is at least partly due to intraocular pressure. Glaucoma is one of the most common causes of blindness in the United States of America. About 2 million Americans have glaucoma, but roughly half are unaware of it. Although glaucoma is generally considered a disorder of the elderly, it can occur in any age group.

In open-angle glaucoma with elevated intraocular pressure (“IOP”), pressure elevation occurs because aqueous humor outflow is inadequate, despite an angle that appears open and relatively normal on gonioscopic examination. In closed-angle glaucoma, elevated IOP occurs when normal drainage of the aqueous humor from the eye is sufficiently prevented by a physical obstruction of the peripheral iris.

Often, glaucoma is treated with medication, or laser therapy. If these treatments fail, or are thought likely to fail, filtration surgery is tried. However, in certain situations (especially when medication cannot be tolerated) filtration surgery may be used initially. Patients taking glaucoma drugs are subject to side effects which can include bronchospasm and shortness of breath; depression and fatigue; impotence; hair loss; heart failure; and bradycardia. Surgical therapy for primary open-angle and normal-pressure glaucoma includes laser trabeculectomy or a guarded filtration procedure, and possibly tube shunts or ciliodestructive procedures. Argon laser trabeculoplasty may be performed as initial treatment in patients in whom medical therapy fails, or in patients unable to tolerate medications. Within 2 to 5 years after such therapies, about 50% of treated patients may require additional medical or surgical therapy due to insufficient IOP control.

In light of the above, there is a need in the art for method and apparatus to treat glaucoma that are inexpensive, that are simple to use, that have few side effects, that can be administered by non-technical personnel, and that can be administered to adults, children and seniors without regard to pre-existing health conditions.

### SUMMARY OF THE INVENTION

One or more embodiments of the present invention satisfy one or more of the above-identified needs in the art. In particular, one embodiment of the present invention is a method for use in treating glaucoma of a patient's eye which comprises a step of vibrating the eye.

### BRIEF DESCRIPTION OF THE DRAWING

FIG. 1 shows a side view of a treatment device that is fabricated in accordance with one embodiment of the present invention, which FIG. 1 shows how the treatment device is positioned when in use;

FIG. 2 shows a back view of the treatment device shown in FIG. 1;

FIG. 3 shows a cross section of the treatment device shown in FIG. 1;

FIG. 4 shows a side view of a treatment device that is fabricated in accordance with another embodiment of the present invention;

FIG. 5 shows a front view of one embodiment of the treatment device shown in FIG. 4;

FIG. 6 shows a side view of a treatment device that is fabricated in accordance with still another embodiment of the present invention, which FIG. 6 shows how the treatment device is positioned when in use, and which FIG. 6 exposes a portion of the inside of the device;

FIGS. 7 and 8 show side views of alternative embodiments of treatment devices that are fabricated in accordance with the present invention.

### DETAILED DESCRIPTION

The inventor has discovered that glaucoma involving high intraocular pressure may be treated by vibrating a patient's eye to slowly reduce the pressure. In addition, the vibration may be accompanied by one or more of heating the eye, subjecting it to magnetic flux, and exerting a predetermined force on the eye. It is believed that subjecting the eye to magnetic flux has a healing effect, i.e., by producing an anti-inflammatory effect, and that warming and vibrating the eye help to increase blood flow and fluid exchange. It is believed that this helps to relieve inflammation, and promotes natural drainage by opening up the trabecular meshwork, thereby allowing natural drainage to occur.

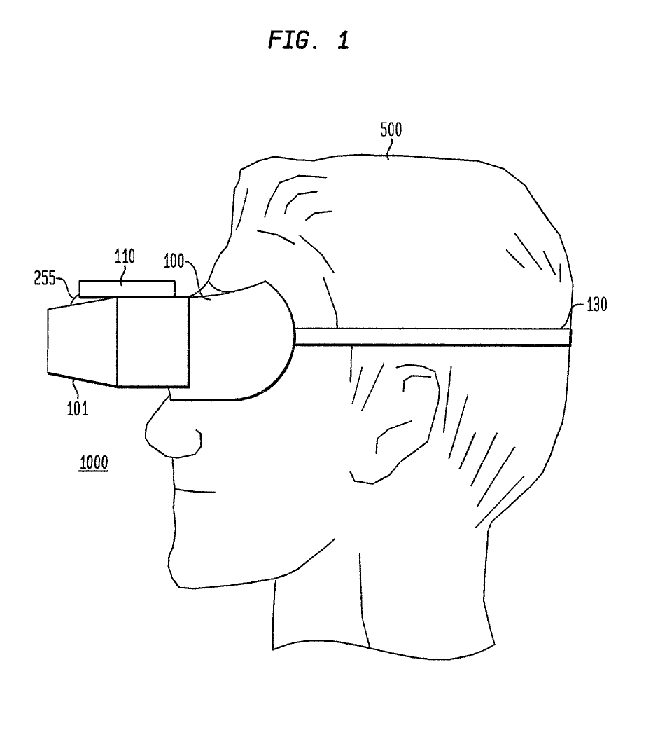

FIG. 1 shows a side view of treatment device 1000 that is fabricated in accordance with one embodiment of the present invention, and FIG. 1 shows how treatment device 1000 is positioned when it is in use. As shown in FIG. 1, treatment device 1000 comprises frame portions 100 and 101 that hold other components of treatment device 1000. In accordance with one embodiment of the present invention, frame portion 100 wraps around head 500 of the patient like a pair of goggles. As further shown in FIG. 1, electronic components enclosure 110 is affixed to frame portion 100, and multi-conductor electrical cable 255 connects to components inside frame portions 100 and 101. In accordance with one embodiment of the present invention, frame portions 100 and 101 are fabricated from plastic (for example, and without limitation, ABS plastic), and in accordance with another embodiment frame portions 100 and 101 are fabricated from metal (for example, and without limitation, aluminum). Many other materials for use in fabricating frame portions 100 and 101 can be routinely determined by one of ordinary skill in the art without undue experimentation.

In accordance with one embodiment of the present invention, and as shown in FIG. 1, frame portion 100 is held to head 500 by band 130, and band 130 is attached to frame portion 100. As shown in FIG. 1, in use, band 130 is looped over head 500. In accordance with one embodiment of the present invention, band 130 is fabricated from an elastic fabric or material, and in accordance with other embodiments, band 130 is fabricated from a flexible material, and further comprises an attachment mechanism such as, for example, and without limitation Velcro™. Many other materials and/or attachment mechanisms for use in fabricating band 130 can be routinely determined by one of ordinary skill in the art without undue experimentation.

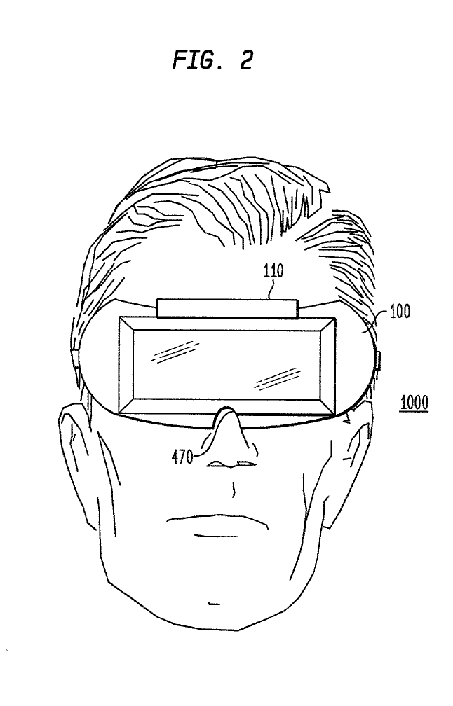

FIG. 2 shows a back view of treatment device 1000. As seen in FIG. 2, frame portion 100 includes indentation area 470 to provide a better fit over the patient's nose. In accordance with one embodiment of the present invention, a padding is affixed to frame 100 to cover indentation area 470 to reduce irritation to the patient whenever treatment device 1000 is in use. Many other materials and alternative designs to prevent such irritation can be routinely determined by one of ordinary skill in the art without undue experimentation.

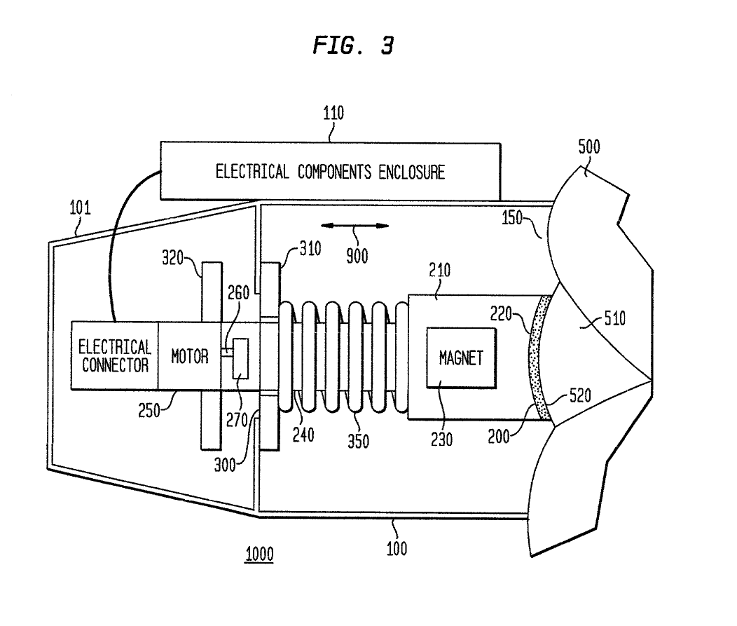

FIG. 3 shows a cross section of treatment device 1000 with eye 510 (eye 510 is closed) protruding through opening 150 in frame portion 100 as frame portion 100 is pressed against a user's face. As shown in FIG. 3, in use, eyelid 520 is positioned to abut heater 200 that covers one end of tube or box 210 (referred to hereafter as tube 210). Side 220 of tube 210 comprises an eye receptacle in the shape of a cup-like concavity that is designed to receive eye 510. As further shown in FIG. 3, the cup-like concavity of side 220 is covered by heater 200. In accordance with one embodiment of the present invention, heater 200 comprises a heating element that is integrated into a flexible fabric. In one such embodiment, heater 200 is powered by a battery, and a backside of heater 200 has an adhesive material disposed thereon that is used to affix heater 200 to the cup-like concavity in side 220. The battery could be a disposable or a rechargeable battery (for example, and without limitation, a 9 volt battery) that snaps into a battery holder in electronic components enclosure 110. Heater 200 is commercially available from many places, for example, and without limitation, from Heater Designs, Inc. of Bloomington, Calif., Symtec Incorporated of Minneapolis, Minn., Translogic, Inc. of Huntington Beach, Calif., H-Heat Industries of Lewiston, Mont., and so forth. In accordance with one embodiment of the present invention, voltage applied to heater 200 is regulated to maintain the temperature of heater 200 in a range from about 100° F. to about 103° F., and typically no more than about 104° F. A suitable regulator may be fabricated in accordance with any one of a number of methods that are well known to those of ordinary skill in the art (for example, and without limitation, utilizing a conventional voltage regulator and a potentiometer, or utilizing a conventional current limiter in accordance with any one of a number of methods that are well known to those of ordinary skill in the art). Further, in accordance with one such embodiment of the present invention, treatment device 1000 includes an electrical adjustment mechanism (for example, and without limitation, a thermostat) that enables the user or a medical practitioner to set and adjust the temperature of heater 200, and even to turn heater 200 off, if desired. Such an electrical adjustment mechanism may be fabricated in accordance with any one of a number of methods that are well known to those of ordinary skill in the art. In accordance with one embodiment of the present invention, the regulator and the electrical adjustment mechanisms are located in electronic components enclosure 110. Further, in accordance with one embodiment of the present invention, user access is provided in a conventional manner to the electrical adjusting mechanism for the purpose of setting and/or adjusting the temperature, and/or turning off heater 200.

In accordance with one embodiment of the present invention, a gel pad (not shown) would be affixed to heater 200 by, for example, and without limitation, double sided tape. The gel pad would have an area the same as or larger that that of a closed eyelid, and be about 1/16″ to ⅛″ thick. The gel pad would be disposable to maintain sterilization.

As further shown in FIG. 3, magnet 230 is disposed in tube 210. Magnet 230 is designed in accordance with any one of a number of methods that are well known to those of ordinary skill in the art so that (when treatment device 1000 is in use) a magnetic field produced by magnet 230 is directed into eye 510 through the eye receptacle to cover, at least, a volume that includes the trabecular meshwork of eye 510. In accordance with one embodiment of the present invention, in this volume, magnet 230 would have a flux in a range from about 100 gauss to about 2500 gauss. Magnet 230 may be a permanent magnet, and many commercial permanent magnets are available that can produce suitable magnetic fields. For example, and without limitation, aluminum-nickel-cobalt (sometimes referred to as Alnico) magnets, and rare earth magnets such as neodymium-iron-boron and samarium-cobalt magnets may be used to fabricate magnet 230.

In addition, magnet 230 may be an electromagnet. For example, in accordance with one embodiment of the present invention, magnet 230 is an electromagnet that has a cylindrical coil. Further, magnet 230 is disposed in tube 210 so that its flux is directed in a predetermined direction. An appropriate electromagnet that is powered, for example, and without limitation, by a battery, may be designed in accordance with any one of a number of methods that are well known to those of ordinary skill in the art. The battery could be a disposable or a rechargeable battery (for example, and without limitation, a 9 volt battery) that snaps into a battery holder in electronic components enclosure 110. For an embodiment that includes an electromagnet, a suitable regulator may be fabricated in accordance with any one of a number of methods that are well known to those of ordinary skill in the art to regulate the magnetic flux by, for example, regulating voltage applied to a coil of the electromagnet (for example, utilizing a conventional voltage regulator and a potentiometer in accordance with any one of a number of methods that are well known to those of ordinary skill in the art). Further, in accordance with one such embodiment of the present invention, treatment device 1000 includes an electrical adjustment mechanism that enables the user or a medical practitioner to set and adjust the level of the magnetic flux of magnet 230, and even to turn magnet 230 off, if desired. Such an electrical adjustment mechanism may be fabricated in accordance with any one of a number of methods that are well known to those of ordinary skill in the art. In accordance with one embodiment of the present invention, the regulator and the electrical adjustment mechanism are located in electronic components enclosure 110. Further, in accordance with one embodiment of the present invention, user access is provided in a conventional manner to the electrical adjusting mechanism for the purpose of setting and/or adjusting the magnetic flux, and/or turning off magnet 230.

In accordance with one embodiment of the present invention, the polarity of the magnetic flux can be changed. In accordance with one such embodiment wherein magnet 230 comprises permanent magnets, tube 210 is fabricated, for example, and without limitation, so that magnet 230 is removable. For example, in accordance with one embodiment, tube 210 may have cap that is affixed to tube 210 by being screwed thereon. In use, to reverse the polarity of the magnetic flux, the cap is removed, magnet 230 is realigned, and the cap is screwed back onto tube 210. In accordance with one such embodiment wherein magnet 230 comprises an electromagnet, to reverse the polarity of the magnetic flux, the polarity of the voltage applied to a coil may be switched in accordance with any one of a number of methods that are well known to those of ordinary skill in the art, for example, by using a switch contained in electronic components enclosure 110, and which switch is accessible by a user.

Side 220 of tube 210 that abuts heater 200 is fabricated from a material that enables the magnetic field produced by magnet 230 to emerge from tube 210. However, other sides of tube 210 may (but are not required to) be fabricated of a material, for example, and without limitation, that contains the magnetic field produced by magnet 230. Thus, for example, tube 210 can be fabricated from nylon, acrylic, ABS plastic, Delrin of Dupont, Inc., polyvinyl chloride (“PVC”) plastic, chlorinated polyvinyl chloride “CPVC”) plastic, polypropylene plastic, polycarbonate, polyethylene, teflor (fluoropolymer), polytetrafluoroethylene (“PTFE”), perfluoroalkoxy (“PFA”), ethylene tetrafluoroethylene copolymer (“ETFE”), fluorinated ethylene-propylene, polyfluorinated fluoride (“PVDF”), polyetheretherketone (“PEEK”) plastic, polyamide (terlon), polyethermide (“ULTEM”), PBI, polymide, Vespel (polyimide), phenolic plastics, and so forth.

As further shown in FIG. 3, tube 210 is fixedly attached to tube or box 240 (referred to hereafter as tube 240). Tube 240 may be glued to tube 210, or tube 240 may be screwed to tube 210 using flanges, or tube 240 may be affixed to tube 210 using any one of a number of methods that are well known to those of ordinary skill in the art depending on the particular materials used to fabricate tubes 210 and 240. Tube 240 may be fabricated from plastic or from metal. Many materials for use in fabricating tube 240 can be routinely determined by one of ordinary skill in the art without undue experimentation, including those listed above for use in fabricating tube 210.

As shown in FIG. 3, tube 240 extends back through opening 300 in frame portion 100, and has a hollow portion (or channel) disposed therein. The hollow portion need not extend along the entire length of tube 240. Motor 250 is disposed in the hollow portion of tube 240, and is fixedly attached to tube 240. For example, in one embodiment, a periphery of a cross section of motor 250 may be substantially the same shape and size as a cross section of the hollow portion of tube 240. In such an embodiment of the present invention, motor 250 may be glued inside the hollow portion of tube 240. In one such embodiment, motor 250 may be inserted (for example, press fit) into tube 240 from the rear, and a cap may then inserted (or screwed) over the rear of tube 240. In another embodiment, motor 250 may be inserted (for example, press fit) into tube 240 from the front, and then tube 240 may be affixed (for example, and without limitation, screwed to) to tube 210.

In one embodiment of the present invention, motor 250 may be a DC motor that is powered, for example, and without limitation, by a battery. The battery could be a disposable or a rechargeable battery (for example, and without limitation, a 9 volt battery) that snaps into a battery holder in electronic components enclosure 110. As shown in FIG. 3, shaft 260 extends out of motor 250, and out-of-balance weight 270 is affixed to shaft 260. Motor 250, shaft 260, and out-of-balance weight 270 form a vibrator. As will be readily appreciated, whenever motor 250 is powered, shaft 260 rotates, and so too does out-of-balance weight 270. As a result of rotation of out-of-balance weight 270, motor 250 vibrates. Further, since motor 250 is affixed to tube 240, whenever motor 250 vibrates, tube 240 and tube 210 also vibrate. Finally, whenever eye 510 is pressed against heater 200, the vibration is coupled to eye 510. As such, the vibration produced by the vibrator is coupled to eye 510 through the eye receptacle.

In accordance with one embodiment of the present invention, motor 250 vibrates at frequencies that are adjustable in a range of frequencies from about 3 cycles per sec (3 cps) to about 500 cps. For example, a typical frequency of vibration may be about 90 cps. A suitable regulator may be fabricated in accordance with any one of a number of methods that are well known to those of ordinary skill in the art to regulate the frequency of vibration by, for example, and without limitation, regulating voltage applied to motor 250. For example, such a frequency regulation might utilize a conventional voltage regulator and a potentiometer in accordance with any one of a number of methods that are well known to those of ordinary skill in the art. Further, in accordance with one embodiment of the present invention, treatment device 1000 includes an electrical adjustment mechanism that enables the user or a medical practitioner to set and adjust the frequency of vibration, and even to turn off motor 250, if desired. Such an electrical adjustment mechanism may be fabricated in accordance with any one of a number of methods that are well known to those of ordinary skill in the art. In accordance with one embodiment of the present invention, the regulator and the electrical adjustment mechanism are located in electronic components enclosure 110. Further, in accordance with one embodiment of the present invention, user access is provided in a conventional manner to the electrical adjusting mechanism for the purpose of setting and/or adjusting the frequency of vibration, and/or turning off motor 250, if desired.

In accordance with one embodiment of the present invention, the area of opening 300 in frame portion 100 is larger than a cross-sectional area of tube 240, and as such, tube 240 may be moved about in the plane of opening 300. This enables a position of the cup-like concavity of side 220 to be moved to accommodate various positions of eye 510.

As shown in FIG. 3, plate 310 is disposed inside frame 100, and has an opening through which tube 240 extends. In accordance with one embodiment of the present invention, the opening in plate 310 is large enough so that tube 240 may move in and out through the opening in plate 310, and opening 300 in frame 100 along the direction indicated by arrow 900. To better understand this, assume there is an embodiment where: tube 240 is cylindrical, opening 300 is circular, the opening in plate 310 is circular, and the periphery of plate 310 is circular. Then, for example, if an outside diameter of tube 240 is 0.75″, a diameter of opening 300 might be 1.125″, a diameter of the opening in plate 310 might be 0.875″, and a diameter of the periphery of plate 310 might be 1.625″ (i.e., the diameter ought to be larger than the diameter of opening 300). Plate 310 may be fabricated from plastic or metal, however, use of plastic may reduce chatter when motor 250 vibrates. Many other materials for use in fabricating plate 310 can be routinely determined by one of ordinary skill in the art without undue experimentation, including the use of pads.

As shown in FIG. 3, collar 320 is affixed to tube 240, for example, by a setscrew (not shown). An area of a cross section of collar 320 (perpendicular to the direction indicated by arrow 900) is sufficiently larger than an area of opening 300 in frame portion 100, that collar 320 cannot be pulled through opening 300. As such, collar 320 acts as a stop for movement of tube 210 in a direction towards eye 510. Collar 320 may be fabricated from plastic or metal, however, use of plastic may reduce chatter when motor 250 vibrates. Many other materials for use in fabricating plate collar 320 can be routinely determined by one of ordinary skill in the art without undue experimentation, including the use of pads.

The cross-sectional areas of plate 310 and collar 320 are chosen to be so large so that, at the outermost displacement (along a direction that is perpendicular to the direction indicated by arrow 900) of a central axis of tube 240 from a center of opening 300, plate 310 and collar 320 fully cover opening 300.

The embodiment shown in FIG. 3 includes a force applicator that applies a force to eye 510. As shown in FIG. 3, the force applicator is embodied as spring 350 that is disposed about tube 240 between tube 210 and plate 310. To better understand this, assume there is an embodiment where tube 240 is cylindrical, and the opening in plate 310 is circular. Then, spring 350 might also have a circular cross section whose diameter is larger than a diameter of the opening in plate 310, and less than a largest dimension across a cross section of tube 210 (perpendicular to the direction indicated by arrow 900). As such, spring 350 urges tube 210 in a direction (with respect to frame portion 100) toward eye 510. As set forth above, the distance of travel towards eye 510 is limited by collar 320, which acts as a stop. Spring 350 may be a metal spring or a plastic spring. Many other materials for use in fabricating plate spring 350 can be routinely determined by one of ordinary skill in the art without undue experimentation. In accordance with one embodiment of the present invention, a cross section of spring 250 is so large that plate 310 is not used.

In accordance with one embodiment of the present invention, the elastic constant of spring 350 is chosen so that when spring 350 urges tube 210 against eye 510 (when frame 100 is disposed against head 500), the maximum force applied to eye 510 is about 25 grams. Of course this includes a margin for error to account for additional forces caused by vibration, if any. In accordance with another embodiment of the present invention, the force exerted against eye 510 is monitored by a force monitor. The force monitor measures the distance spring 350 is compressed (a distance of travel of tube 210 along the direction indicated by arrow 900 away from eye 510) from a pre-determined position. The force monitor determines the force applied by spring 350 as a product of the elastic constant and the distance spring 350 is compressed plus a predetermined calibration factor. A number of methods are well known to those of ordinary skill in the art for measuring the distance spring 350 is compressed. By monitoring this distance using, for example, and without limitation, an ultrasonic sensor that provides a digital readout, conventional electronics (including a microprocessor) can determine the force and provide a signal whenever the force approaches or exceeds a predetermined limit. In accordance with one embodiment of the present invention, the signal is used to energize an audible alarm and/or a visible alarm in the form of a bell or a flashing light, respectively. In accordance with another embodiment, the signal is used to activate a force release mechanism. In accordance with one embodiment, the force release mechanism comprises a solenoid (not shown) that is disposed, for example, and without limitation, in frame portion 101. In use, the signal activates the solenoid and causes tube 210 to move along the direction indicated by arrow 900 and away from eye 510, thereby reducing or removing the force applied by spring 350. In accordance with one such embodiment, to cause such motion of tube 210, energizing the solenoid attracts a metal (for example, a core of motor 250) affixed to tube 210 along the direction indicated by arrow 900 and away from eye 510.

In accordance with one embodiment of the present invention, electronics for treatment device 1000 may include a timer (for example, 0 to 10 min.) which is located in electronic components enclosure 110. Further, in accordance with one embodiment of the present invention, user access is provided in a conventional manner to the timer for the purpose of setting and/or adjusting the time of treatment, and/or turning treatment device 1000 on or off. In use, a user or a medical practitioner would place treatment device 1000 in position over closed eyelid 520, and treatment would last, for example, from about 3 min. to about 6 min. In accordance with one embodiment, separate controls might exist for each eye.

It should be appreciated that embodiments of the present invention can be powered using batteries, or they may be powered using other sources of power such as, for example, and without limitation, an AC electrical power source, a solar power source, and so forth, as well as combinations of batteries and alternative sources of power.

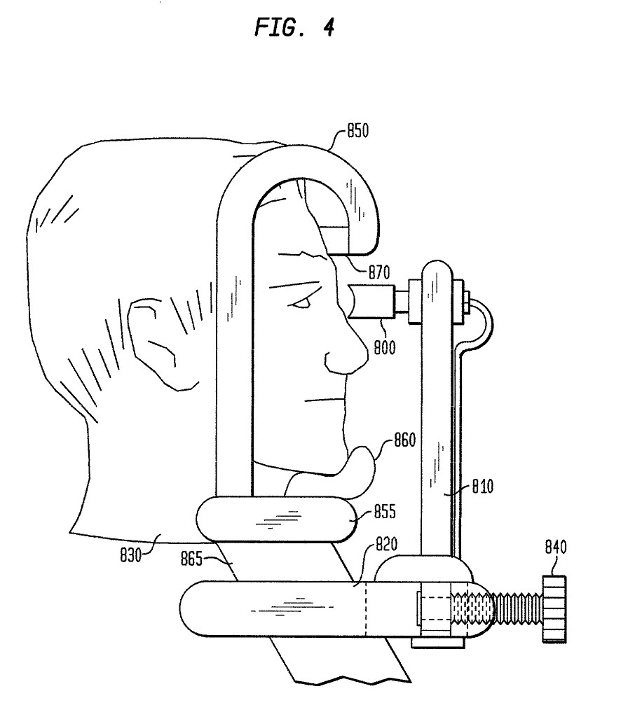

FIG. 4 shows an alternative embodiment of a treatment device wherein treatment device 800 is affixed to arm 810. As shown in FIG. 4, arm 810 is attached to swing arm 820 of eye examination equipment 830. Swing arm 820 includes a hinged arrangement (not shown) affixed to eye examination equipment 830 that enables swing arm 820 to swing treatment device 800 in or out of service. In accordance with one embodiment of the present invention, swing arm 820 snaps or locks in place, as dictated by the hinged arrangement, and swing arm 820 can be moved so that treatment device 800 may be located over either eye. In addition, swing arm 820 includes adjustment mechanism 840 that enables a practitioner to move treatment device close to or away from the patient's eye. As further shown in FIG. 4, eye examination equipment 830 includes head fixture 850 that is supported by stand 865 and cross beam 855. Head fixture 850 includes padding 860 to support a patient's chin, and padding 870 to support the patient's head in a predetermined position.

In use, swing arm 820 enables treatment device 800 to be swung to a side so the patient can be positioned in a chair, for example, and without limitation, like that found in an optometrist's or an ophthalmologist's office. Then, the patient would place his/her chin on padding 860, and rest his/her head against padding 870. Next, the patient would be asked to close his/her eyes. Next, treatment device 800 would be pivoted into a treatment position. When treatment device 800 is swung into the treatment position, treatment device 800 should be disposed so that the patient's eyelid does not touch the treatment device. Next, adjustment mechanism 840 would be used to move treatment device 800 into treatment position. Treatment device 800 includes a force applicator like that described above (not shown for ease of understanding this embodiment) that, as was described above, may be embodied as a spring, and a force monitor like that described above (not shown for ease of understanding this embodiment) that, as was described above, may be embodied as a mechanism to measure a distance the spring is compressed. The force monitor would send a signal to conventional electronics to determine the force applied to the patient's eye. Then, an output from the electronics would be applied to, for example, and without limitation, a digital readout that would indicate the force applied to the patient's eye when adjustment mechanism 840 urges treatment device 800 to touch the patient's eyelid. The force may be adjusted by the use of adjustment mechanism 840. Thus, a fixed, force would push treatment device 800 onto the eye, the force could be in a range of from about 1 gram to about 25 grams on the eye.

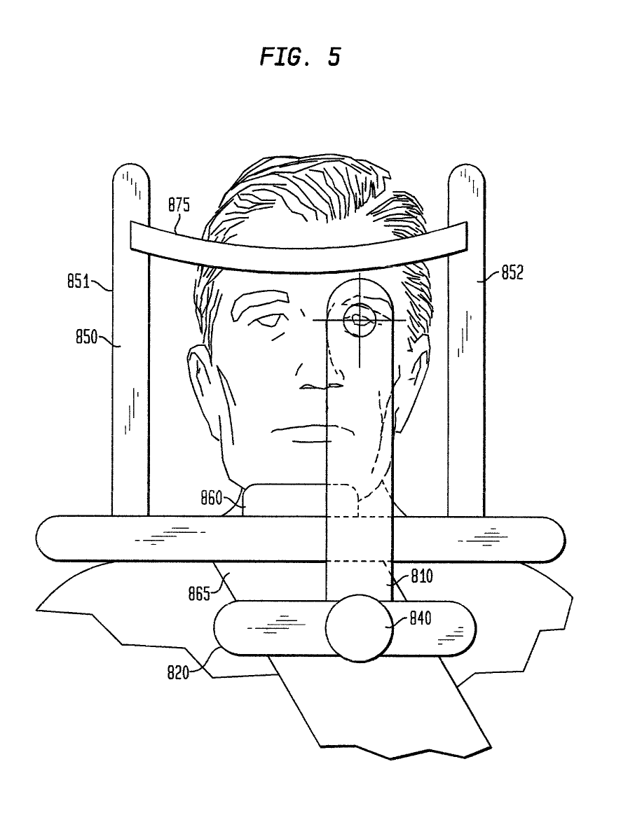

FIG. 5 shows a front view of one embodiment of the treatment device shown in FIG. 4. As shown in FIG. 5, head fixture 850 includes band 875 disposed between poles 851 and 852. In accordance with one embodiment of the present invention, padding 860 is affixed to band 875.

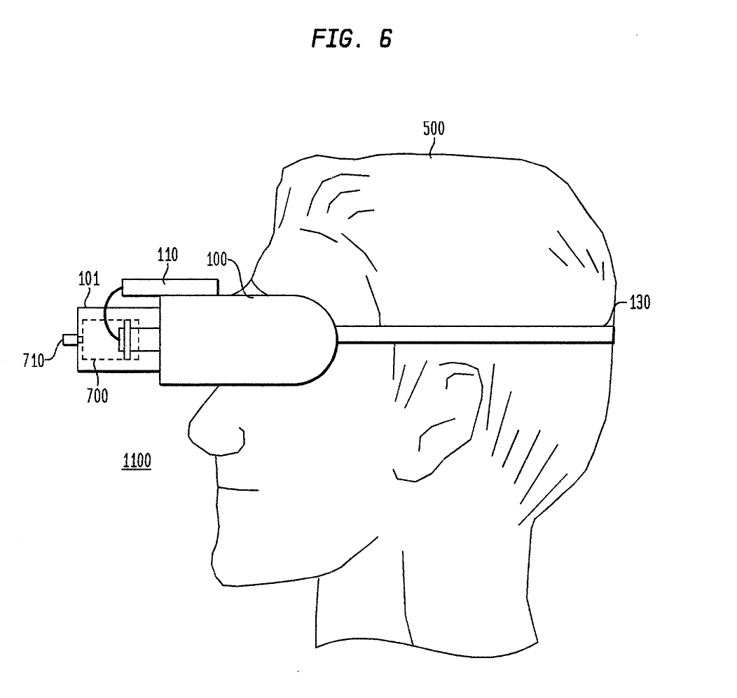

FIG. 6 shows a side view of treatment device 1100 that is fabricated in accordance with one embodiment of the present invention, and FIG. 6 shows how treatment device 1100 is positioned when it is in use. In addition, FIG. 6 exposes a portion of the inside frame portion 101. As shown in FIG. 6, treatment device 1100 comprises frame portions 100 and 101 that hold other components of treatment device 1100. As further shown in FIG. 6, motion arrester 700 is affixed to tube 210. The operation of motion arrester 700 can be controlled by motion arrester adjustment mechanism 710. In accordance with one or more embodiments of the present invention, motion arrester 700 is a dashpot, an actuator, a snubber, a shock absorber, or an airpot that are well known to those of ordinary skill in the art. For example, for an airpot, motion arrester adjustment mechanism 710 would be a valve that: (a) if turned one way, allows air to enter the airpot so that a piston can move, and (b) if turned another way, prevents the piston from moving. The use of a shock absorber type device to fabricate motion arrester 700 enables the motion of tube 210 into frame 100 to proceed slowly. As a result, tube 210 would make a soft landing against a user's patient's eyelid. After treatment, tube 210 would be pushed back into frame portions 100 and 101, and motion arrester adjustment mechanism 710 would be adjusted to cause motion arrester 700 to hold tube 210 in a fixed position, ready for the next treatment.

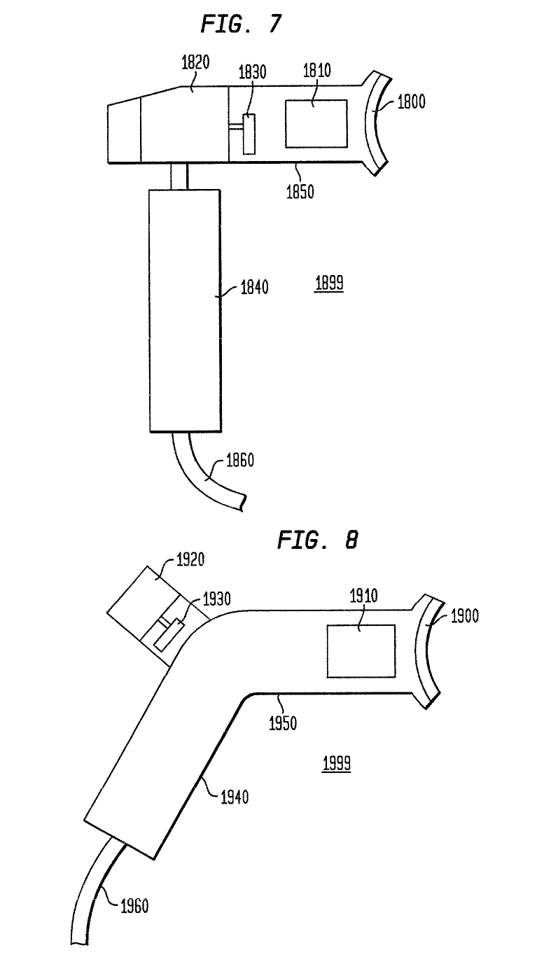

FIGS. 7 and 8 show side views of treatment devices 1899 and 1999, respectively, that are fabricated in accordance with the present invention. Treatment devices 1899 and 1999 are hand-held treatment devices. As shown in FIG. 7 structure 1840 is held by a user to place and hold treatment device 1899 against the user's closed eyelid. As shown in FIG. 8, structure 1940 is held by the user to place and hold treatment device 1999 against the user's closed eyelid. Structures 1840 and 1940 may be any shape suitable for fitting a person's hand, and may be fabricated from plastic, or from any other suitable material such as, and without limitation, a metal, for example. aluminum.

As shown in FIGS. 7 and 8, structure 1840 supports body 1850 of treatment device 1899, and structure 1940 supports body 1950 of treatment device 1999, respectively. As shown in FIG. 8, structure 1940 holds body 1950 at an angle to reduce user hand fatigue during treatment. Similarly, the length of structures 1840 and 1940, and angles at which they hold body 1840 and 1940, respectively, may be varied to provide a large number of alternative embodiments of the present invention. Further, body 1840 and body 1940 may be fabricated from plastic, or from any other suitable material such as, and without limitation, a metal, for example, aluminum.

Heater and pad combination 1800 shown in FIG. 7 are fabricated in the same manner, and are affixed to treatment device 1899 in the same manner, described above with respect to heater 200 and the gel pad of embodiments of treatment device 1000 (refer to FIG. 3). Similarly, heater and pad combination 1900 shown in FIG. 8 are fabricated in the same manner, and are affixed to treatment device 1999 in the same manner, described above with respect to heater 200 and the gel pad of embodiments of treatment device 1000 (refer to FIG. 3).

Magnets 1810 and 1910 shown in FIGS. 7 and 8, respectively, are fabricated in the same manner described above with respect to magnet 230 of embodiments of treatment device 1000 (refer to FIG. 3). Further, a vibrator comprised of motor 1820 and out-of-balance weight 1830 shown in FIG. 7 is fabricated in the same manner described above with respect to motor 250 and out-of-balance-weight 270 of embodiments of treatment device 1000 (refer to FIG. 3). Similarly, a vibrator comprised of motor 1920 and out-of-balance weight 1930 shown in FIG. 8 is fabricated in the same manner described above with respect to motor 250 and out-of-balance-weight 270 of embodiments of treatment device 1000 (refer to FIG. 3). As one can readily appreciate from this, embodiments of a treatment device in accordance with the present invention exist wherein a vibrator is placed at various locations on and about the treatment device.

Note that the embodiments shown in FIGS. 7 and 8 do not utilize a force applicator like that shown in FIG. 3. Further, cables 1860 and 1960 shown in FIGS. 7 and 8, respectively, enable electrical power to be distributed to the pertinent components of treatment devices 1899 and 1999, respectively. In use, a user would hold treatment device 1899 by structure 1840, or hold treatment device 1999 by structure 1940, energize the vibrator by, for example, activating a switch (not shown), optionally energize the heater by, for example, activating a switch (not shown), and press the respective treatment device against the user's closed eyelid.

Although various embodiments that incorporate the teachings of the present invention have been shown and described in detail herein, those skilled in the art can readily devise many other varied embodiments that still incorporate these teachings. For example, in accordance with one or more embodiments of the present invention, conventional electronics would include a microprocessor. As a further example, embodiments of the present invention are not limited to the types of vibrators shown and described above. In particular, further embodiments include the use of vibrators including, for example, and without limitation, a pulsed solenoid, an ultrasonic vibrator, as well as a whole host of commercially available hydraulic, pneumatic, electric or electromagnetic vibrators. As a still further example, although a force applicator was described wherein a single spring surrounded a tube, further embodiments exist wherein multiple springs are utilized, which multiple springs may affixed between, for example, two plates having openings through which a tube may translate along the directions shown by arrow 900.

What is claimed is:

1. A method for use in treating glaucoma of a patient's eye which comprises steps of:
vibrating the eye.

2. The method of claim 1 which further comprises steps of:
directing magnetic flux into the eye.

3. The method of claim 1 which further comprises steps of:
heating the eye.

4. The method of claim 1 which further comprises steps of:
exerting a force on the eye.

5. The method of claim 1 which further comprises steps of:
directing magnetic flux into the eye; and
heating the eye.

6. The method of claim 5 which further comprises steps of exerting a force on the eye.

7. The method of claim 1 wherein the step of vibrating the eye comprises vibrating the eye at a frequency in a range from about 3 cycles per sec to about 500 cycles per second.

8. The method of claim 2 wherein the magnetic flux is in a range from about 100 gauss to about 2500 gauss.

9. The method of claim 3 wherein the step of heating heats the eye to a temperature in a range from about 100° F. to about 104° F.

10. The method of claim 4 wherein the force is in a range of from about 1 gram to about 25 grams.

11. An apparatus for use in treating glaucoma of a patient's eye that comprises:
a receptacle that fits over an eyelid of the eye; and
a vibrator coupled to the receptacle.

12. The apparatus of claim 11 which further comprises:
a magnet adapted to direct magnetic flux through the receptacle.

13. The apparatus of claim 11 which further comprises:
a heater coupled to the receptacle.

14. The apparatus of claim 11 which further comprises:
a force applicator coupled to the receptacle.

15. The apparatus of claim 14 wherein the force applicator includes a spring.

16. The apparatus of claim 12 which further comprises:
a magnet adapted to direct magnetic flux through the receptacle; and
a heater coupled to the receptacle.

17. The apparatus of claim 16 which further comprises:
a force applicator coupled to the receptacle.

18. The apparatus of claim 17 further comprising a frame adapted to hold the apparatus against the patient's head.

19. The apparatus of claim 17 further comprises a tube that holds the receptacle;
wherein the tube extends through an opening in a plate and wherein the tube is disposed to translate back and forth through the opening; and
wherein the force applicator comprises a spring disposed along the tube adapted to exert a force on the plate and the tube.

20. The apparatus of claim 19 wherein the opening is larger than the tube wherein the tube can be translated laterally in the opening.

21. The apparatus of claim 20 further comprising a motion arrester affixed to the tube.

22. The apparatus of claim 21 wherein the motion arrester includes one or more of a dashpot, an actuator, a snubber, a shock absorber, an airpot mechanism.

23. The apparatus of claim 12 wherein the magnet comprises a permanent magnet.

24. The apparatus of claim 12 wherein the magnet comprises an electromagnet.

25. The apparatus of claim 24 wherein the electromagnet includes a mechanism to adjust the amount of magnetic flux and to change the polarity of the magnet.

26. The apparatus of claim 13 wherein the heater comprises a heating element integrated into a flexible fabric.

27. The apparatus of claim 13 wherein the heater includes a mechanism to monitor and adjust a temperature.

28. The apparatus of claim 13 wherein the heater is affixed to the receptacle; and a gel pad is removably affixed to the heater.

29. The apparatus of claim 11 wherein the vibrator includes a mechanism to adjust a frequency of vibration.

30. The apparatus of claim 11 wherein the vibrator comprises a motor and an out-of-balance weight.

31. The apparatus of claim 11 wherein the vibrator comprises a pulsed solenoid.

32. The apparatus of claim 11 which further comprises an adjustable timer.

33. The apparatus of claim 14 which further comprises a force monitor.

34. The apparatus of claim 33 wherein the force monitor generates a signal when the force is larger than a predetermined amount.

35. The apparatus of claim 34 which further comprises an alarm that is activated in response to the signal.

36. The apparatus of claim 34 which further comprises a force release mechanism that is activated in response to the signal displace the receptacle.

37. The apparatus of claim 33 wherein the force applicator comprises a spring, and the force monitor measures a distance of compression of the spring to monitor force.
